(19) United States
(12) Patent Application Publication
(10) Pub. No.: US 2008/0288990 A1
(43) Pub. Date: Nov. 20, 2008

(54) Interactive Broadcasting System

(75) Inventors: Jean Koh, Gyeonggi-do (KR); In-Kwon Kim, Seoul (KR)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Varovision Co., Ltd., Seoul (KR)

(21) Appl. No.: 11/568,177

(22) PCT Filed: Apr. 22, 2005
(86) PCT No.: PCT/KR2005/001172

§ 371 Date: Jul. 30, 2008

(30) Foreign Application Priority Data
Apr. 23, 2004 (KR) 10-2004-0028159

(51) Int. Cl. H04N 7/173

(52) U.S. Cl. 725/93

(57) ABSTRACT

Disclosed herein is an interactive broadcasting system. The interactive broadcasting system includes a web server, a content providing server, a streaming server, a broadcast control server, and a content control server. The web server provides a web page through the Internet and controls a web connection. The content providing server provides content. The streaming server streams the content to the mobile terminal, and receives messages transmitted from the mobile terminal. The broadcast control server manages the broadcast schedule of the content and generates details of the picture construction. The content control server generates a picture depending on the details of a picture construction, and performs picture combination by overlaying the generated picture on a content picture provided by the content providing server, and transmits the combined picture to the streaming server, thus allowing the combined picture to be streamed to the mobile terminal by the streaming server.

### TECHNICAL FIELD

The present invention relates, in general, to an interactive broadcasting system that provides real-time broadcast content or previously stored broadcast content to mobile terminals, and also provides broadcast content in which users' requests are reflected.

### BACKGROUND ART

Generally, video and audio signals are converted into digital signals according to an established algoritim or scheme, and are then compressed, encoded and multiplexed. A compressed digital signal, that is, a bitstream, includes video, audio and other information. These signals are transferred to a reproducing device through a transmission line, or are stored in recording media and then transferred to the reproducing device.

A digital reproducing device, such as a Digital Video Disk (DVD) system, a digital VCR, or a computer system containing a multimedia player solution, that reproduces multiplexed multimedia data, such as video data and audio data, includes a decoding means for reproducing the bitstream. This decoding means generates reproducible signals by demultiplexing, decompressing and decoding the bitstream depending on a compression algorithm. The decoded video and audio signals are outputted through the screen or speaker of the reproducing device, and are rendered such that a user can enjoy reproduced multimedia.

Digital content is provided to users through various methods. These days, as data service through a mobile communication network is possible with the development of mobile communication technology and terminal technology, various types of digital content services are required, and users desire not only to receive digital content through mobile terminals but also to see their opinions reflected in the broadcast content. Therefore, technology for satisfying the user's desires is in demand.

### DISCLOSURE OF THE INVENTION

Accordingly, the present invention has been made keeping in mind the above problems occurring in the prior art, and an object of the present invention is to provide an interactive broadcasting system that provides not only real-time broadcast content or predetermined broadcast content to the users' mobile terminals but also provides broadcast content in which users' requests are reflected.

In order to accomplish the above object, the present invention provides an interactive broadcasting system that provides digital content to a plurality of mobile terminals through a mobile communication network and reflects messages from the terminals in broadcast content.

The system includes: a web server for providing a web page through the Internet and controlling a web connection; a content providing server for providing content; a streaming server for streaming the content, which is requested by a mobile terminal connected to the web server, to the mobile terminal, and receiving messages transmitted from the mobile terminal; a broadcast control server for managing the broadcast schedule of the content provided by the content providing server and generating details of a picture construction depending on details included in messages received by the streaming server; and a content control server for generating a picture depending on the details of a picture construction generated by the broadcast control server, performing picture combination by overlaying the generated picture on a content picture provided by the content providing server, and transmitting the combined picture to the streaming server, thus allowing the combined picture to be streamed to the mobile terminal by the streaming server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a connection between an interactive broadcasting system and a mobile communication network according to the present invention;

FIG. 2 is a block diagram illustrating an embodiment of a mobile terminal according to the present invention;

FIG. 3 is a block diagram illustrating an embodiment of a Moving Picture Experts Group (MPEG) processing unit according to the present invention;

FIG. 4 is a block diagram illustrating an embodiment of an interactive broadcasting system according to the present invention;

FIG. 5 is a block diagram illustrating an embodiment of a content control server and the connection relationship thereof according to the present invention; and

FIG. 6 is a flowchart illustrating an interactive broadcasting process according to the present invention.

### BEST MODE FOR CARRYING OUT THE INVENTION

Embodiments of the present invention are described in detail with reference to the accompanying drawings below.

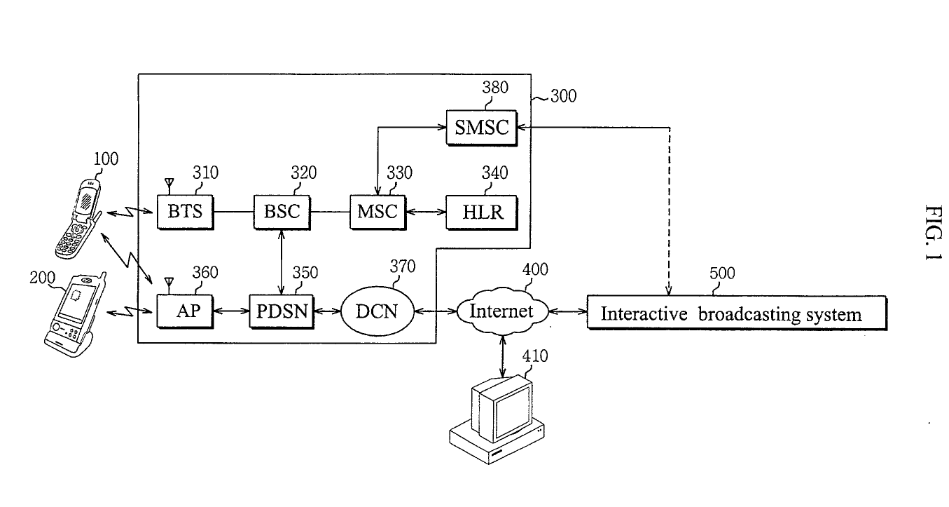

FIG. 1 is a block diagram illustrating a connection between an interactive broadcasting system and a mobile communication network according to the present invention.

Referring to FIG. 1, the mobile communication network 300 includes a mobile terminal 100, a Base Transceiver System (hereinafter referred to as a “BTS”) 310 configured to perform wireless communication, a Base Station Controller (hereinafter referred to as a “BSC”) 320 configured to control the BTS 310, a Mobile Switching Center (hereinafter referred to as an “MSC”) 330 connected with the BSC 320 to exchange calls, a Home Location Register (hereinafter referred to as an “HLR”) 340 connected with the MSC 330 to manage users' location information, a Short Message Service Center (hereinafter referred to as an “SMSC”) 380 connected with the MSC 330 to process short messages, a Packet Data Service Node (hereinafter referred to as a “PDSN”) 350 connected to the BSC 320 to provide packet data service, and a Data Core Network (hereinafter referred to as a “DCN”) 370 connected with the PDSN 350.

Furthermore, the PDSN 350 is connected with an access Point (hereinafter referred to as an “AP”) 360 for providing wireless Local Area Network (LAN) service to mobile terminals 100 and 200, and the DCN 370 is connected to the interactive broadcasting system 500 of the present invention through the Internet 400.

The interactive broadcasting system 500 provides previously stored moving image content or real-time moving image content to the mobile terminals 100 and 200 through a mobile communication network. The mobile terminals 100 and 200 are provided with streaming moving images from the interactive broadcasting system 500 and reproduce the provided mages, so that the users can view the moving images.

The moving image content may be moving image MPEG data including audio data, or audio MPEG data having only audio data (for example, MPEG Layer-3 (MP3)), and each of the mobile terminals 100 and 200 includes a decoder that is capable of decoding the MPEG data.

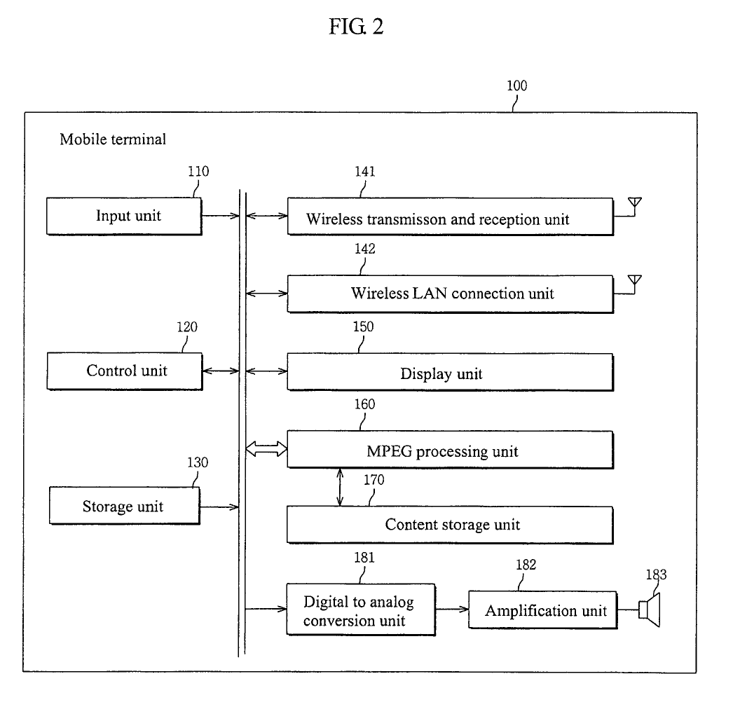

FIG. 2 is a block diagram illustrating an embodiment of a mobile terminal according to the present invention.

Referring to FIG. 2, the mobile terminal 100 according to the present invention includes a control unit 120 for controlling overall operation, an input unit 110 for receiving operation commands from a user, a storage unit 130 for storing an application program that controls data storage and content reproduction, a wireless transmission and reception unit 141 for performing wireless transmission and reception with the BTS 310 of a mobile communication network, a wireless LAN connection unit 142 for performing wireless LAN connection with the AP 360, a display unit 150 for displaying operational information and moving images, a digital to analog conversion unit 181 for converting digital signals into analog signals to output sound, and an amplification unit 182 for amplifying the analog signals converted by the digital to analog conversion unit and outputting the amplified analog signals to a speaker 183.

Furthermore, the mobile terminal 100 includes an MPEG processing unit 160 for processing moving image data, that is, M PEG data, and a content storage unit 170 for storing the processed image data.

The mobile terminal 100 according to the present invention having the above-described construction is provided with streaming moving images from the above-described interactive broadcasting system 500 using the application program stored in the storage unit 130, and processes the data provided through the MPEG processing unit 160, so that the user can view moving images.

In this case, the application program for reproducing the moving images allows commands for reproducing, stopping and rewinding moving images inputted through the input unit 110 by the user, to be transmitted to the interactive broadcasting system 500 through a session separate from the session through which the moving images are streamed. Accordingly, the interactive broadcasting system 500 receives commands for reproducing, stopping and rewinding moving images, and controls the moving images according to the commands.

Furthermore, when a predetermined input received through the input unit 110 exists while the moving images are being reproduced, the application program activates a message input window on a side portion of the display unit 150 and allows a message to be inputted through the input window using the input unit 110.

Thereafter, when the inputting of the message is completed, the application program transmits the messages to the interactive broadcasting system 500, which streams the moving images through a predetermined session. The above-described application program transmits messages along with the ID number of a currently streamed program, and the ID number of the mobile terminal, details of which will be described later.

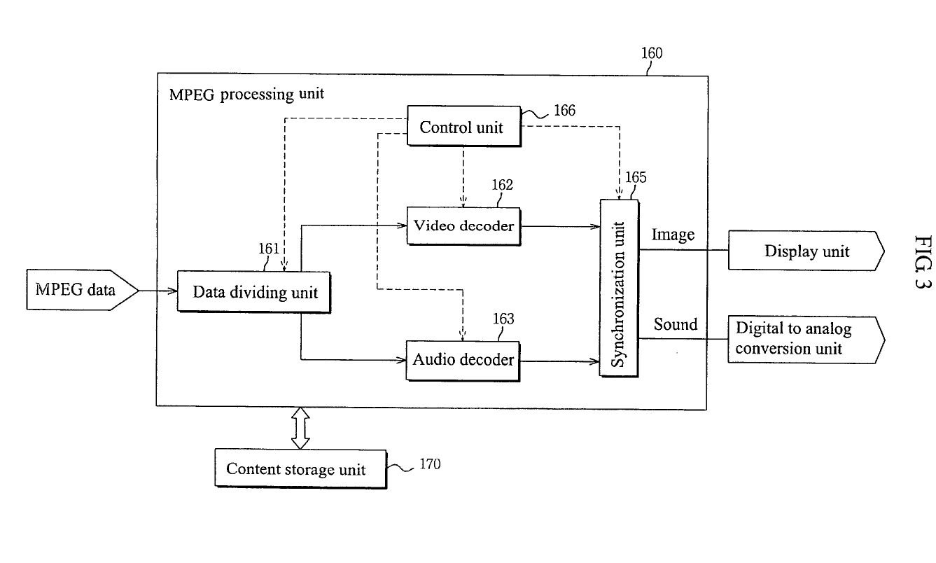

FIG. 3 is a block diagram illustrating an embodiment of an MPEG processing unit according to the present invention.

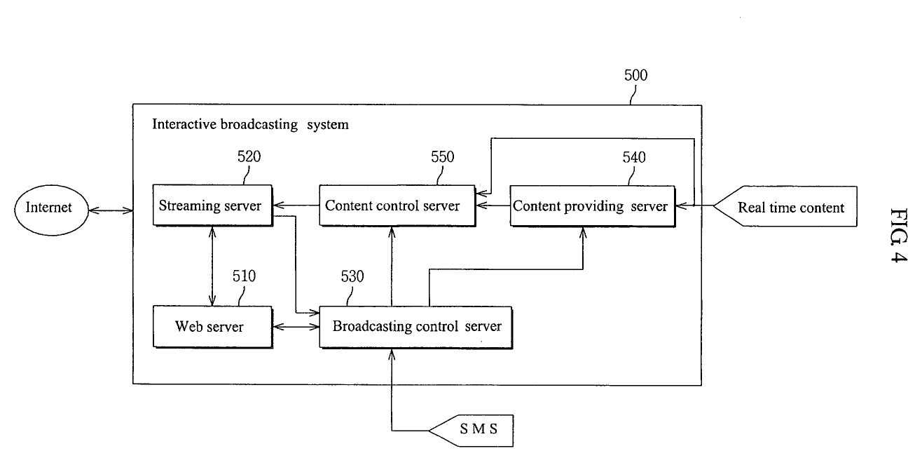

Referring to FIG. 4, the MPEG processing unit 160 according to the present invention is configured to process moving image MPEG data that is streamed from the interactive broadcasting system 500, and includes a data dividing unit 161 for dividing the MPEG data into video data and audio data, a video decoder 162 for decoding the video data, which is divided by the data dividing unit 161, and an audio decoder 163 for decoding the audio data, which is divided by the data dividing unit 161.

Furthermore, the MPEG processing unit 160 according to the present invention includes a synchronization unit 165 for synchronizing the video data decoded by the video decoder 162, with the audio data decoded by the audio decoder 163 and a control unit 166 for controlling overall operation.

FIG. 4 is a block diagram illustrating an embodiment of an interactive broadcasting system according to the present invention.

Referring to FIG. 4, the interactive broadcasting system 500 according to the present invention includes a web server 510 for providing a web page through the Internet 400 and controlling web connections, a content providing server 540 for storing and managing broadcast content and providing content depending on users' requests, a content control server 550 for controlling the broadcasting of the content provided from the content providing server 540, a streaming server 520 for providing the streaming MPEG data of moving image content including audio data provided by the content control server 550, or streaming MPEG data including only audio data, to a terminal (a fixed terminal or a mobile terminal).

Furthermore, the interactive broadcasting system 500 according to the present invention includes a broadcast control server 530 for controlling a broadcast schedule. The broadcast control server 530 performs overall broadcast scheduling and content management, and controls the construction of a broadcast picture.

The streaming server 520 streams or downloads the broadcasted content to the terminal using protocols, such as RTP, RTCP, RTSP and HTTP, and can exchange a predetermined message with the terminal through a separate session (for example, a “Real-Time Streaming Protocol (RTSP)” or a “RTP Control Protocol (RTCP)”) while providing streaming or downloading the broadcasted content to the terminal. That is, a session for transmitting content and a session for transmitting and receiving messages are provided separately between the streaming server 520 and the terminal.

A message transmitted to the terminal by the streaming server 520 includes unique information that indicates currently provided content such as a program ID and a broadcasting ID. In this case, the broadcasting ID is unique information for indicating broadcasting, and the program ID is unique information for indicating any one of the various broadcasted content corresponding to the broadcasting ID.

Furthermore, the message transmitted by the terminal includes parameters, such as a terminal ID (for example, a mobile identification number), message transmission time, and message details, along with the program ID and the broadcasting ID.

The streaming server 520 transfers the message, including the parameters transmitted from the terminal, to the broadcast control server 530 and the content control server 550 as an interactive message, thus allowing a user's request to be reflected in the broadcast content.

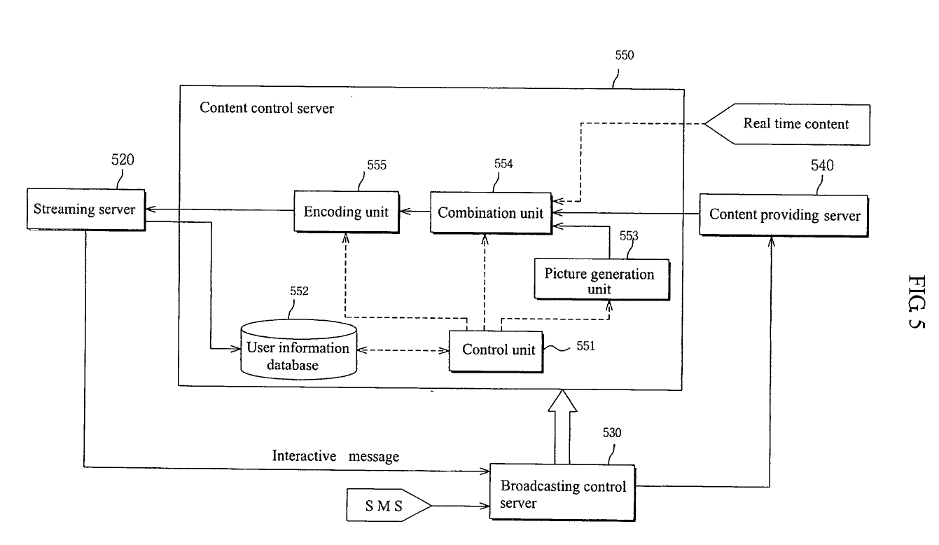

FIG. 5 is a block diagram illustrating an embodiment of a content control server and the connection relationship thereof according to the present invention.

Referring to FIG. 5, the content control server 550 according to the present invention includes a control unit 551 for controlling overall operation, a picture generating unit 553 for generating a picture under the control of the control unit 551, a combination unit 554 for performing picture combination by overlaying the picture generated by the picture generating unit 553, on the content picture provided by the content providing server 540, an encoding unit 555 for encoding data combined by the combination unit 554, and a user information database 552 for storing and managing interactive messages transmitted through the terminals by users.

The encoding unit 555 converts analog and digital video and audio signals into a digital format, for which streaming service is available, by encoding the analog and digital signals appropriately. In this case, encoding formats and parameters follow the control of the broadcast control server 530.

The streaming server 520 according to the present invention not only streams content to the user's terminal but also receives messages transmitted from the user's terminal and transmits them to the broadcast control server 530 and the content control server 550.

Accordingly, the content control server 550 stores the interactive message, which is transmitted through the streaming server 520 from the user's terminal, in the user information database 552. Thereafter, the control unit 551 of the content control server 550 consults the details of the interactive message stored in the user information database 552, which corresponds to a picture generation request from the broadcast control server 530, and performs control so that the predetermined picture is generated through the picture generation unit 553.

Thereafter, the picture generated by the picture generation unit 553 is overlaid with the picture of the content in the combination unit 554. The combined picture data is encoded into a predetermined format in the encoding unit 555 and then transmitted to the streaming server 520.

The interactive broadcasting system 500 having the construction of FIG. 4 or 5 provides content to a user's terminal when a content provision request received from the user's terminal exists, the process of which is as follows:

When a mobile terminal 100 or 200, or a fixed terminal 410, is connected to the web server 510 through the Internet 400, the web server 510 performs user authentication. When a user requests content using any one of terminals 100, 200 or 410, and after the user is authenticated, the web server 510 requests the content providing server 540 to provide the corresponding content according to the user's content request via the broadcast control server 530.

Accordingly, the content providing server 540 provides the corresponding content to the content control server 550, the content control server 550 encodes the content provided by the content providing server 540 so as to be transmitted to the streaming server 520, and the streaming server 520 streams the encoded content to the user's terminal.

Detailed descriptions of the content providing server according to the present invention are made below.

When a user's mobile terminal connected to the web server 510 of the interactive broadcasting system 500 requests broadcast content by content selection, the web server 510 transmits a content request message to the content control server 550 and the content providing server 540 so that the corresponding content is transmitted to the user's mobile terminal. The content providing server 540 transmits the corresponding streaming content data to the user's mobile terminal through the streaming server 520 along with the currently transmitted program and broadcasting IDs. Accordingly, the terminal runs a predetermined application program and reproduces the streaming content using the application program.

In this case, the user can input a message requesting interactive broadcasting through the input unit 110. For this purpose, the terminal displays an input window for displaying the message on the display unit 150 once a predetermined input is received through the input unit 110.

That is, when the user presses specific keys on the input unit 110 while the streaming content is displayed, an input window having a predetermined size is activated on a side portion of the display unit 150, for example, on the lower end portion of the display unit 150. Accordingly, when the user inputs a message through the input window using the input unit 110 and presses a confirmation button, message input is completed.

Thereafter, the user's terminal transmits the message, that is, an interactive message inputted by the user, to the streaming server 520. In this case, the message transmitted from the terminal to the streaming server 520 includes a program ID, broadcasting ID, terminal ID (for example, a mobile identification number), time, and message details.

When receiving the interactive message transmitted from the terminal, the streaming server 520 stores the received interactive message in the user information database 552 through the content control server 550. Furthermore, the streaming server 520 transmits the interactive message transmitted from the terminal to the broadcast control server 530, as well as the content control server 550.

The broadcast control server 530 receives the interactive message, sets a picture construction depending on the message, and transmits a picture generation request message including information about the set picture construction, to the content control server 550.

The picture construction that depends on the interactive message varies with the kind of content currently being provided, and the characteristic of the interactive message transmitted by the user. That is, in the case of public opinion research with respect to currently provided content, the broadcast control server 530 integrates many interactive messages and constructs a picture indicating statistical data resulting from the public opinion research. Furthermore, in the case of details related to fund-raising, the broadcast control server 530 can construct a caption identifying users participating in the fund-raising, or constructs a picture including graphs for indicating information about amounts raised and the like.

The broadcast control server 530 transmits the information about the picture construction to the content control server 550, and the content control server 550 generates a picture corresponding to the picture construction through the picture generation unit 553, and outputs the generated picture to the combination unit 554.

Thereafter, the combination unit 554 synthesizes the picture generated by the picture generation unit 553, and the content provided from the content providing server 540. For this purpose, the combination unit 554 overlays the picture generated by the picture generation unit 553, on the picture of the content transmitted from the content providing server 540, or real-time content transmitted from the outside, and transmits the overlaid data to the encoding unit 555.

The encoding unit 555 encodes the data outputted from the combination unit 554, into a predetermined format under the control of the control unit 551, and outputs the encoded content data to the streaming server 520. In this case, the control unit 551 is provided with encoding information from the broadcast control server 530 and the encoding unit 555.

Thereafter, the streaming server 520 transmits the encoded content data to the user's terminal, so that the terminal can be provided with content.

The interactive broadcasting system according to the above-described present invention can provide various types of user interactive broadcasting, and is described with reference to a flowchart below.

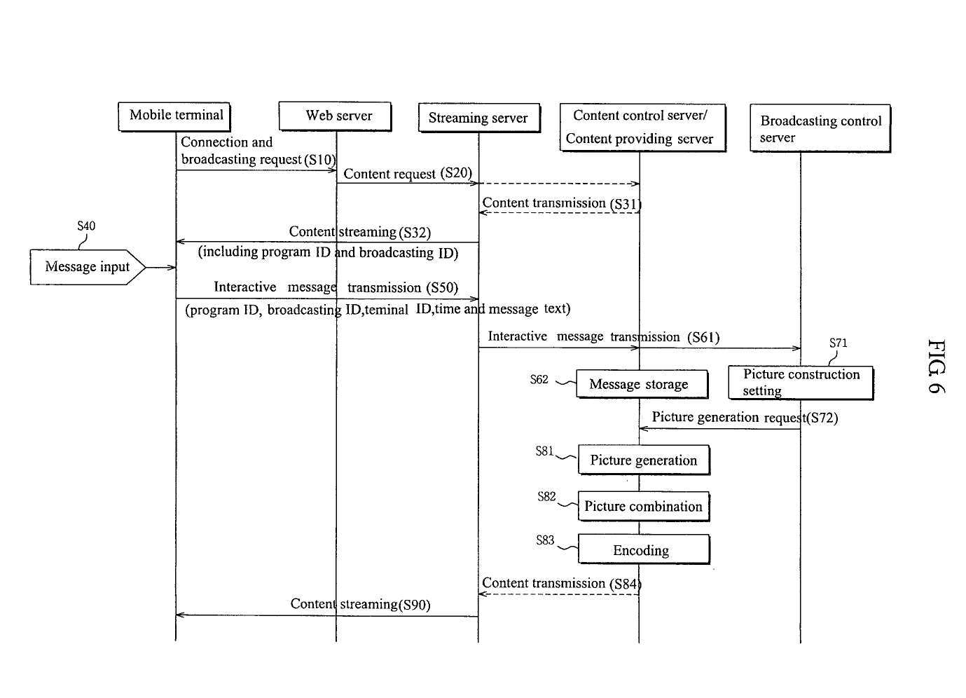

FIG. 6 is a flowchart illustrating an interactive broadcasting process according to the present invention. The embodiment shown in FIG. 6 illustrates a process of reflecting the interactive requests of users provided with broadcast content from the interactive broadcasting system according to the present invention, in a broadcast picture.

Referring to FIG. 6, when a user's mobile terminal connected to the web server 510 of the interactive broadcasting system 500 requests broadcast content by selecting content at step S10, the web server 510 transmits a content request message to the content control server 550 and the content providing server 540 so that the corresponding content is transmitted to the user's mobile terminal.

Thereafter, the content providing server 540 transmits the corresponding content data to the streaming server 520 at step S31, and the streaming server 520 streams the data to the terminal at step S32. In this case, data streamed by the streaming server 520 includes a program ID and a broadcasting ID.

Thereafter, the terminal runs a predetermined application program, and reproduces the streaming content using the application program, thus allowing the user to view the streaming content.

When a predetermined input received from the input unit 110 exists while a moving image is being reproduced, the terminal activates a message input window on a side portion of the display unit 150. Thereafter, at step S50, when a message for interactive broadcasting is inputted through the input unit 110 by the user, the message is set as an interactive message, and is then transmitted to the streaming server 520 that streams moving images through a predetermined session. Furthermore, at step S50, the terminal transmits the message, along with the program and broadcasting IDs of a currently streamed program and the ID number of a mobile terminal.

The streaming server 520 transmits the interactive message received from the terminal, to the content control server 550. Accordingly, the content control server 550 stores the interactive message in the user information database 552.

Furthermore, the streaming server 520 transmits the interactive message, having been transmitted from the terminal, to the broadcast control server 530 as well as to the content control server 550.

The broadcast control server 530 sets picture construction depending on the received interactive message at step S71, and transmit a picture generation request message, including information on the set picture construction, to the content control server 550 at step S72. Accordingly, the content control server 550 generates a picture through the picture generation unit 553 at step S81. The picture generation unit 553 outputs the generated picture to the combination unit 554.

Thereafter, the combination unit 554 combines the picture generated by the picture generation unit 553, and the content provided from the content providing server 540, at step S82. For this purpose, the combination unit 554 overlays the content transmitted from the content providing server 540, or real-time content transmitted from the outside, on the picture generated by the picture generation unit 553, and then transmits the overlaid data to the encoding unit 555.

The encoding unit 555 encodes data outputted from the combination unit 554 into a predetermined format under the control of the control unit 551 at step S83, and outputs the encoded data to the streaming server 520 at step S84. In this case, the control unit 551 is provided with encoding information from the broadcast control server 530, and controls the encoding unit 555.

Thereafter, the streaming server 520 streams the encoded content data to the user's terminal at step S90.

The above-described present invention can provide various types of user interactive broadcasting. In the case of public opinion research, the present invention reflects message details inputted by users in public opinion research, and combines a picture corresponding to statistical data, in a public opinion research content picture, thus being capable of providing a real-time streaming service.

Furthermore, the present invention can perform broadcasting by simply overlaying messages, transmitted by users, on the picture of streaming content. In the case of sportscasting, the present invention allows the users to select from any one of a plurality of cameras using the messages, and provides a picture generated by the selected camera, that is, content, thus being capable of providing multi-angle content.

Furthermore, the present invention can broadcast content in such a way as to receive evaluations of broadcasted content through the users' messages and overlay details of the evaluation on broadcast content.

### INDUSTRIAL APPLICABILITY

As described above, the interactive broadcasting system according to the present invention is effective in that real-time or previously stored digital content can be provided to users' terminals, and the users' requests can be received and reflected in the broadcasted content. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An interactive broadcasting system that provides digital content to a plurality of mobile terminals through a mobile communication network and reflects messages received from the terminals in the broadcast content, the system comprising:
a web server for providing a web page through the Internet and controlling a web connection;
a content providing server for providing content;
a streaming server for streaming the content, which is requested by a mobile terminal connected to the web server, to the mobile terminal, and receiving messages transmitted from the mobile terminal;
a broadcast control server for managing a broadcast schedule of the content provided by the content providing server and generating details of a picture construction depending on details included in messages received by the streaming server; and
a content control server for generating a picture depending on the details of a picture construction generated by the broadcast control server, performing picture combination by overlaying the generated picture on a content picture provided by the content providing server, and transmitting the combined picture to the streaming server, thus allowing the combined picture to be streamed to the mobile terminal by the streaming server.

2. The interactive broadcasting system according to claim 1, wherein the content control server comprises a control unit for controlling operation, a user information database for storing and managing messages, a picture generating unit for generating pictures using the details of picture construction generated by the broadcast control server under control of the control unit, a combination unit for performing picture combination by overlaying the picture generated by the picture generating unit, on the content picture provided by the content providing server, and an encoding unit for encoding the data combined by the combination unit and transmitting the encoded data to the streaming server.

3. The interactive broadcasting system according to claim 2, wherein the content control server comprises a content database for storing real-time content, or storing and managing predetermined content.

4. The interactive broadcasting system according to claim 1, wherein the streaming server streams the content, along with both program and broadcasting Identifications (IDs) of current content, to the mobile terminal.

5. The interactive broadcasting system according to claim 4, wherein:
each of the messages transmitted by the mobile terminals comprise the program and broadcasting IDs of the content provided in the streaming service, a mobile identification number, a message transmission time, and message text; and
the streaming server transfers the received messages to the broadcast control server and the content control server.

6. The interactive broadcasting system according to claim 1, wherein the mobile terminal comprises: a control unit for controlling overall operation; an input unit for receiving operation commands from users, a storage unit for storing an application program that controls data storage and content reproduction, and performing wireless transmission and reception together with the mobile communication network; a wireless transmission and reception unit for receiving content through the mobile communication network; a display unit for displaying operation information and moving images; a digital to analog conversion unit for converting digital signals into analog signals to output sound; an amplification unit for amplifying analog signals converted by the digital to analog conversion unit and outputting the amplified analog signals to a speaker; and a Moving Picture Experts Group (MPEG) processing unit for decoding content received through the wireless transmission and reception unit.

7. The interactive broadcasting system according to claim 6, wherein the MPEG processing unit comprises a data dividing unit for dividing the content data into video data and audio data, a video decoder for decoding the video data divided by the data dividing unit depending on a predetermined format, an audio decoder for decoding the audio data divided by the data dividing unit depending on a predetermined format, and a synchronization unit for synchronizing the video data decoded by the video decoder, with the audio data decoded by the audio decoder.

8. The interactive broadcasting system according to claim 7, wherein:
the video data synchronized by the synchronization unit is transferred to the display unit and then displayed; and
the audio data synchronized by the synchronization unit is transferred to the digital and analog converting unit, converted into analog signals, amplified by the amplification unit and transferred to the speaker.

9. The interactive broadcasting system according to claim 5, wherein the mobile terminal activates a message input window for inputting a message when an input received through the input unit exists while the content is reproduced using the application program, includes program and broadcasting IDs of the content provided by the streaming service, a mobile identification number, and a message transmission time in the message, and transmits the message to the streaming server through a session separate from the session through which the content is streamed.
